(19) United States
(12) Patent Application Publication
(10) Pub. No.: US 2026/0358619 A1
(43) Pub. Date: Nov. 12, 2026

(54) ATTACHMENT FOR VARIABLE MAGNIFICATION OPTIC SCOPE

(71) Applicant: James P. Rosengarth, Raleigh, NC (US)

(72) Inventor: James P. Rosengarth, Raleigh, NC (US)

(21) Appl. No.: 19/205,913

(22) Filed: May 12, 2025

(51) Int. Cl. G02B 23/16; F41G 1/38

(52) U.S. Cl. CPC G02B 23/16; F41G 1/38

(57) ABSTRACT

A scope attachment for a variable magnification firearm optic scope. The scope attachment allows a shooter to a shooter's ability to quickly and accurately change the magnification levels of the scope, and provides both a tactile and visual means of referencing desired magnification levels. The scope attachment uses a one-piece annular split body design that affixes around the magnification ring of the scope. The scope attachment includes a plurality of integral lever arms that extend radially outward from the attachment. The lever arms are also positioned to correspond to select magnification indicia of the magnification ring when the attachment is affixed to the magnification ring.

This invention relates to an attachment for a firearm optic scope, and particularly an attachment that mounts to the magnification ring of a variable magnification optic scope.

### BACKGROUND OF INVENTION

Variable magnification firearm optics offer shooters the ability to adjust magnification levels depending on the situation. Variable magnification firearm optics are advantageous in tactical and competition applications, allowing shooters to adjust for different distances quickly and accurately. Shooters face challenges when switching magnification levels, including maintaining focus and re-calibrating aim for different shooting targets during competitions. Higher magnifications are often equated with greater precision, but smaller fields of view. Shooters have a smaller field of view at higher magnifications, which means that shooters may not see or identify a moving target even if it passes through the field of view.

Conventional variable magnification optics use a rotating magnification ring generally located adjacent to the eye objective that can be manually rotated to adjust the magnification levels quickly and effectively to switch between lower and higher magnifications. Magnification rings generally rotate approximately 180 degrees to vary the magnification levels between the scope's lowest magnification and it's highest magnification. Many variable magnification optics also have a throw lever fitted to the magnification ring that allows a shooter to more easily grasp and rotate the magnification ring. Although the throw lever allows the shooter to adjust the magnification levels, shooters still must visually align indicia markings for each magnification level, resulting in slower target acquisition and time to shot.

### SUMMARY OF INVENTION

The scope attachment of this invention allows a shooter to a shooter's ability to quickly and accurately change the magnification levels of a firearm optic scope, and provides both a tactile and visual means of referencing desired magnification level. The scope attachment uses a one-piece annular split body design that affixes around the magnification ring of the scope. The scope attachment includes a plurality of integral level arms that extend radially outward from the attachment. The lever arms are also positioned to correspond to select magnification indicia of the magnification ring when the attachment is affixed to the magnification ring. In use, a shooter can grasp a lever arm to manually rotate the magnification ring to selectively adjust the magnification level of the scope. A shooter can rotate quickly to orient and visually verify the shooter's desired magnification by rotating the lever arm corresponding to the desired magnification level to align to the fixed marker on the scope or the windage turret, and more generally, to orient and align the desired lever arm vertical relative to the firearm. This allows the shooter to quickly move to the desired magnification with a tactile and visual means to confirm the magnification level. The plurality of lever arms are positioned to give the shooter multiple distinct magnification levels that can be quickly referenced when shooting.

Other advantages will become apparent upon a reading of the following description.

### BRIEF DESCRIPTION OF THE DRAWINGS

The preferred embodiments of the invention have been depicted for illustrative purposes only wherein:

FIG. 1 is a perspective view of an exemplary embodiment of the clamp body of the scope attachment of this invention;

FIG. 2 is a front view of the clamp body of the scope attachment of FIG. 1;

FIG. 3 is a rear view of the clamp body of the scope attachment of FIG. 1;

FIG. 4 is a right side view of the clamp body of the scope attachment of FIG. 1;

FIG. 5 is a left side view of the clamp body of the scope attachment of FIG. 1;

FIG. 6 is a top view of the clamp body of the scope attachment of FIG. 1;

FIG. 7 is a bottom view of the clamp body of the scope attachment of FIG. 1;

FIG. 8 is a partial perspective view of the scope attachment of FIG. 1 affixed to an exemplary embodiment of a variable magnification optic scope;

FIG. 9 is a second partial perspective view of the scope attachment of FIG. 1 mounted to the scope of FIG. 8;

FIG. 10 is partial rear view of the scope attachment showing the attachment in a first position;

FIG. 11 is partial rear view of the scope attachment showing the attachment in a second intermediate position;

FIG. 12 is partial rear view of the scope attachment showing the attachment in a third position;

FIG. 13 is a perspective view of a second exemplary embodiment of the clamp body of the scope attachment of this invention;

FIG. 14 is a front view of the clamp body of the scope attachment of FIG. 13;

FIG. 15 is a rear view of the clamp body of the scope attachment of FIG. 13;

FIG. 16 is a right side view of the clamp body of the scope attachment of FIG. 13;

FIG. 17 is a left side view of the clamp body of the scope attachment of FIG. 13;

FIG. 18 is a top view of the clamp body of the scope attachment of FIG. 13; and

FIG. 19 is a bottom view of the clamp body of the scope attachment of FIG. 13.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized, and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

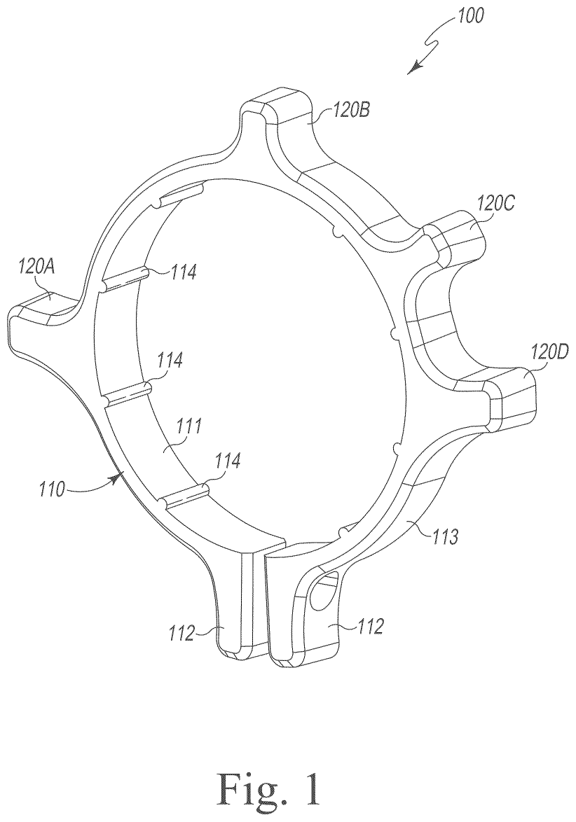

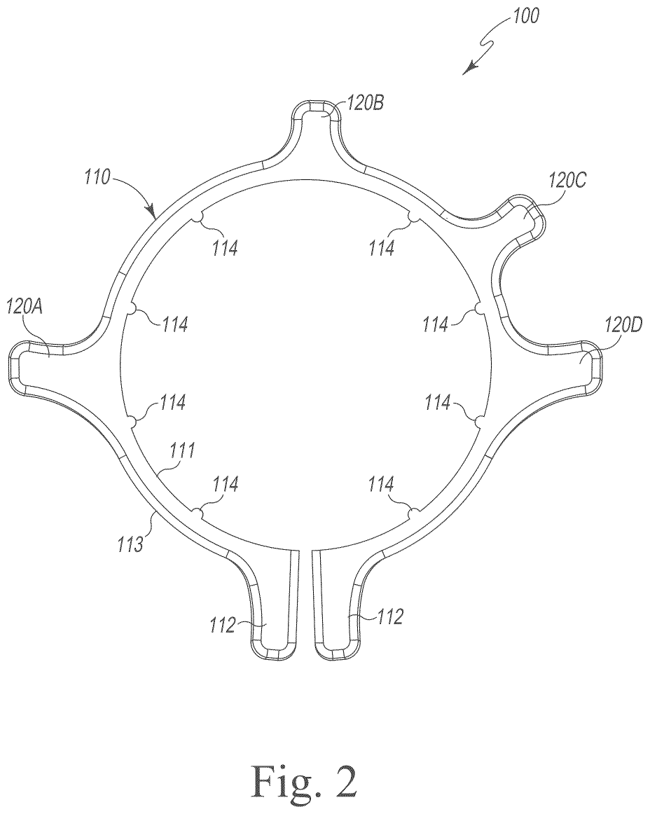

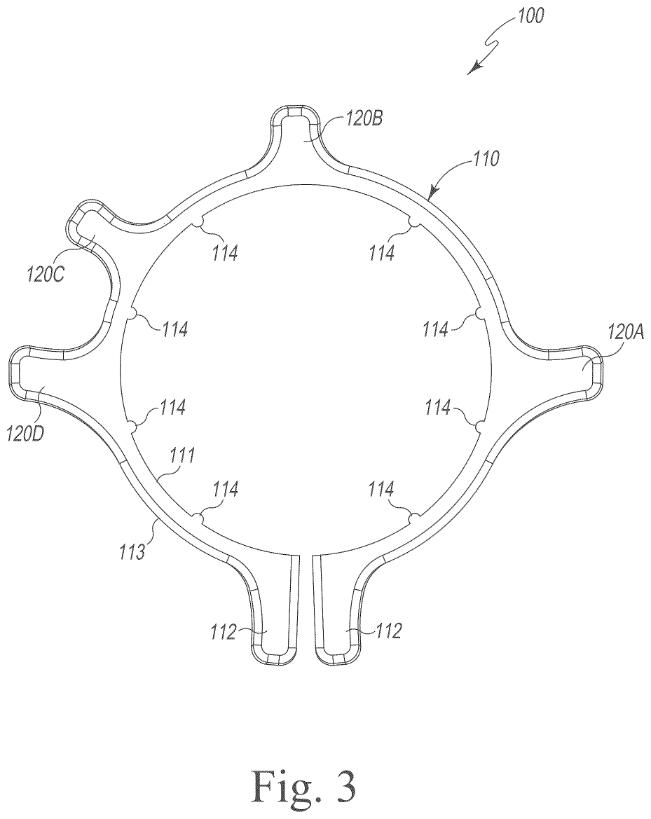

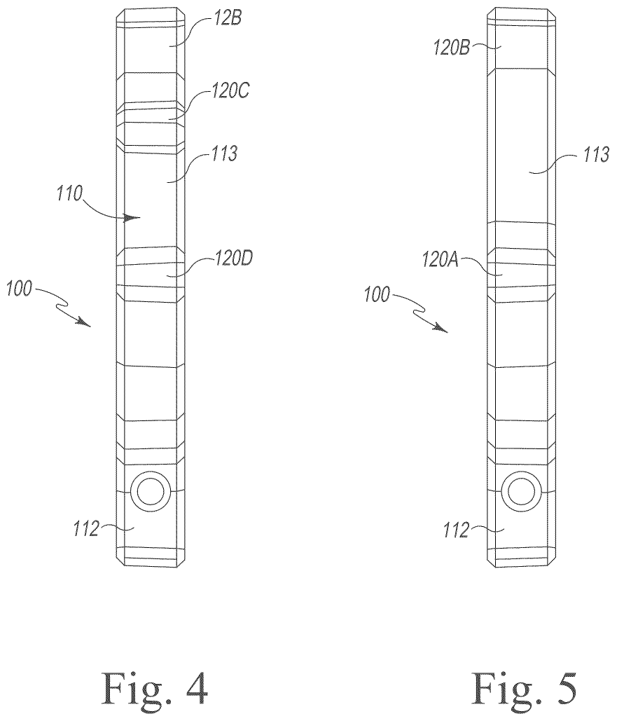

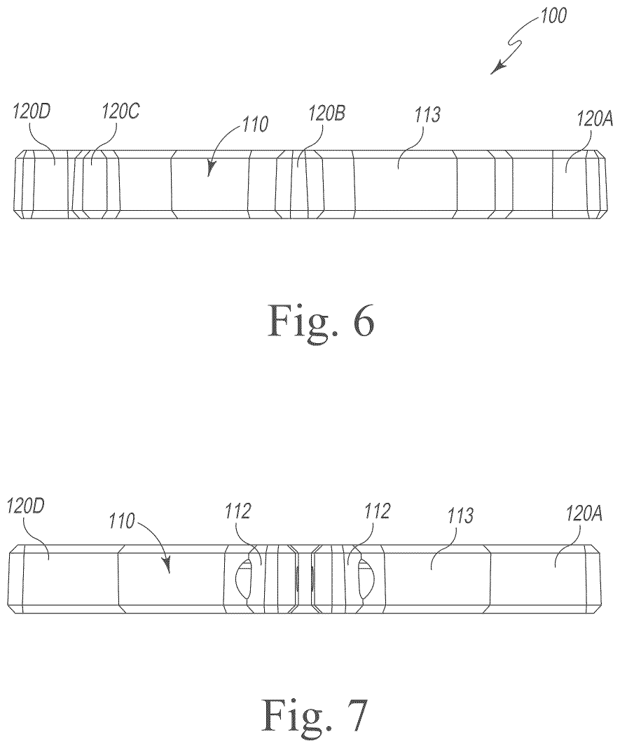

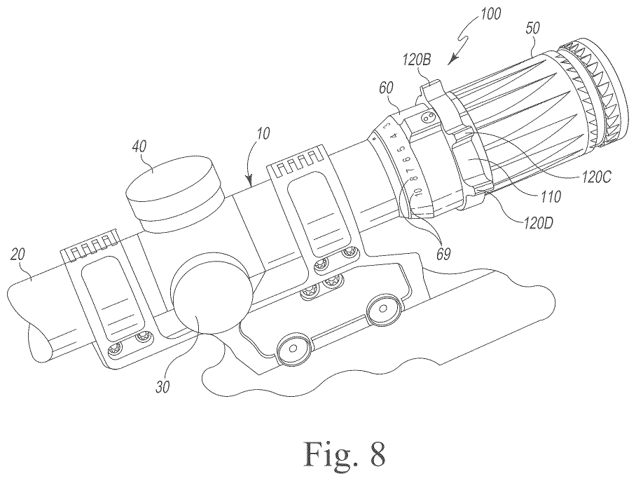

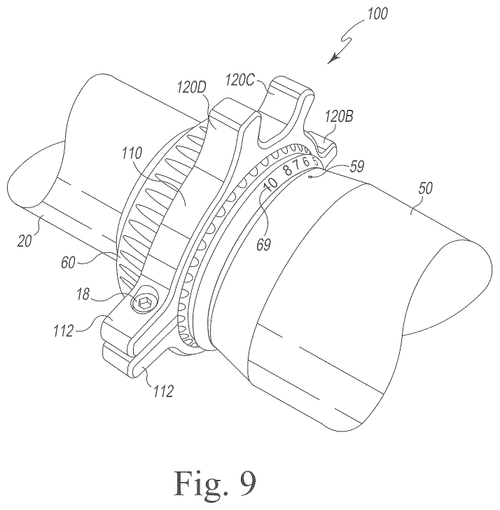

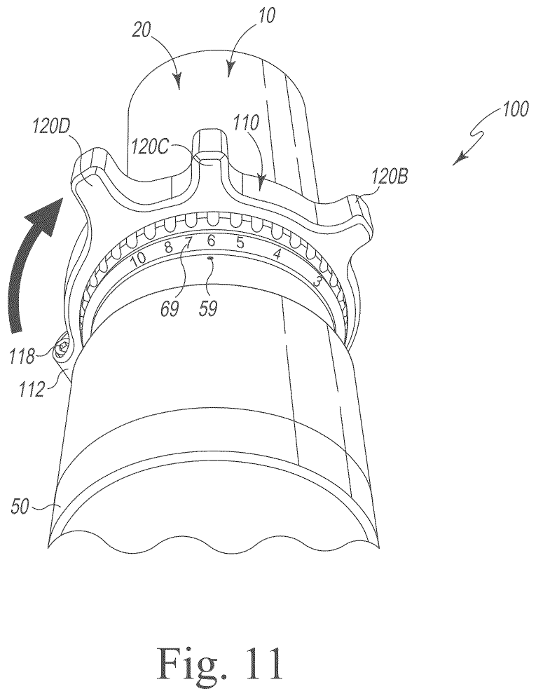

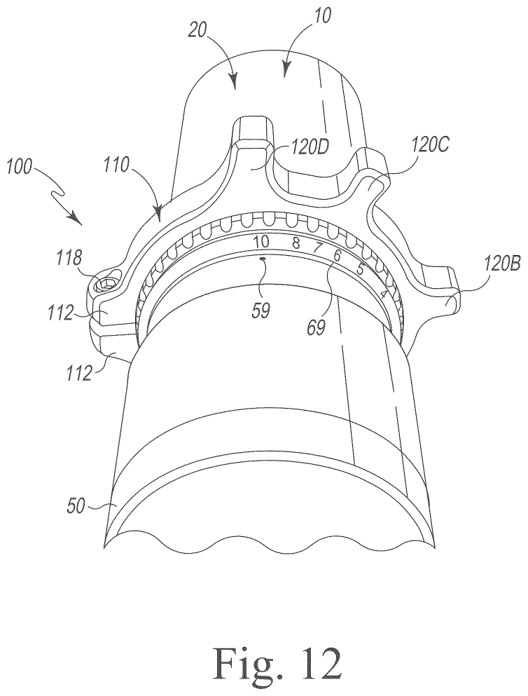

Referring now to the drawings, FIGS. 1-12 illustrate an exemplary embodiment of the scope attachment, which is designated generally as reference numeral 100. Scope attachment 100 mounts to the magnification ring of variable magnification scope optics. Scope attachment 100 is designed and intended to replace conventional single magnification levers and enhance a shooter's ability to quickly and accurately change the magnification levels of the scope and provides both a tactile and visual means of referencing desired magnification levels. Scope attachment 100 may be configured to mount to any style or model of variable magnification optic scope within the teaching of this invention.

For simplicity of illustration and explanation, scope attachment 100 is illustrated mounted to a conventional low-power variable optics (“LPVOs”) variable magnification optic, or “Scope” 10, such as the VUDU from Eotech, LLC. of Plymouth, Michigan. Scope 10 includes a tubular scope body 20, an objective lens (not shown), elevation turrets 30, windage turret 40, ocular eye piece 50, and a rotating magnification adjustment ring 6. Scope body 20 is the main tube or housing of the rifle scope that contains the optical components and provides a mounting platform for the scope on the rifle. The objective lens at the front of scope body 20 collects and focuses light from the environment and brings it into the scope. Elevation and windage turrets 30 and 40 are the small knobs on top and/or on the side of scope body 20 that allow you to adjust the scope's reticle to the firearm's point of impact. Ocular eyepiece 50 is the end of scope body 20 that the shooter looks through.

Magnification ring 60 is a rotating annular collar fitted to the scope body 20 forward of ocular eyepiece 50. Magnification ring 60 rotates degrees to allow the shooter to adjust the magnification level of scope 10, changing the size of the target image in the scope's field of view. As shown, magnification ring 60 rotates approximately 180 degrees to change the magnification levels between 1× and 10× magnification. Magnification ring 60 has a series of recessed longitudinal channels 61 machined or formed in the side walls of magnification ring 60. Channels 61 generally provide a shooter with a more tactile surface for rotating magnification ring 60 between magnification levels. In other scope embodiments, the magnification ring may have a series of raised ridges, grooves, knurling or other forms of texturing on the side walls of the ring to assist in manually engaging and rotating the ring body. Magnification ring 60 also has a series of indicia 69 that corresponds to the specific magnification level for scope 10. Magnification ring 60 is manually rotated to selectively align indicia 69 to a fixed index marker 59 on ocular eyepiece 50 corresponding to the shooter's desired magnification level for scope 10. Generally, index marker 59 is aligned with the rotational axis of turret 40, which is generally at the 12 o'clock (vertical) position on the firearm, when scope 10 is mounted to a firearm.

Scope attachment 100 uses a one-piece annular split body design formed, molded, fabricated or printed from a suitable light-weight polymer material. In alternative embodiments, the scope attachment may be stamped, formed or machined from suitable light-weight metals, such as aluminum. Scope attachment 100 is dimensioned and configured to affix around the magnification ring 60. Scope attachment 100 has a generally annular clamp body 110 that terminates in a pair of spaced ears 112 clamped together by a threaded fastener 118. Clamp body 110 has an inner surface 111 and an outer surface 113. A plurality of ribs 114 extend radially inward from inner surface 111. Ribs 114 are dimensioned and configured to seat within channels 61 of magnification ring 60 to securely affix the clamp body to magnification ring 60 and prevent it from shifting about the ring.

Clamp body 110 also includes a plurality (four shown) of integral level arms 120. Lever arms 120 extend radially outward from outer surface 113 and are spaced generally around approximately 180 degrees of the circumference of clamp body 110. Lever arms 120 are also positioned to correspond to select magnification indicia 69 of magnification ring 60 when scope attachment 100 is affixed to the ring. As shown when affixed to magnification ring 60, one lever arm 120A is positioned to correspond to the lowest magnification indicia and one lever arm 120 D is position to correspond to the highest magnification indicia. The other lever arms 120B and 120C are selectively positioned to correspond to other magnification indicia. While four lever arms are illustrated in the present embodiment, it should be noted that other embodiments of the scope attachment may have any number of lever arms and those lever arms may be positioned to correspond to any desired magnification level.

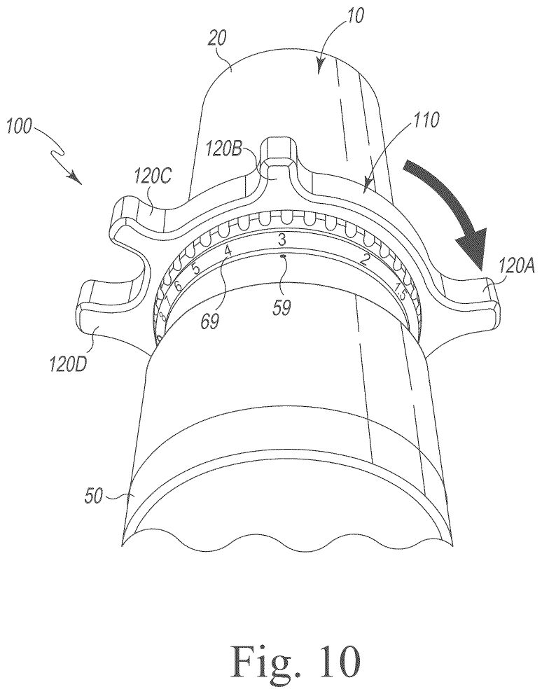

In use (FIGS. 10-12), scope attachment 100 is affixed to magnification ring 60 so that lever arms 120 are aligned with its particular magnification indicia 69. A shooter can grasp any of the lever arms 120 to rotate magnification ring 60 to selectively adjust the magnification level of scope 10. Shooter can rotate and quickly orient and visually verify the shooter's desired magnification by rotating a lever arm 120 corresponding to the desired magnification level to align with the fixed marker 59 or windage turret 40, and be more in generally, aligned vertical to the firearm. This allows the shooter to quickly move to the desired magnification with a tactile and visual means to confirm the magnification level. The plurality of lever arms 120 are positioned to give the shooter multiple distinct magnification levels that can be quickly referenced when shooting.

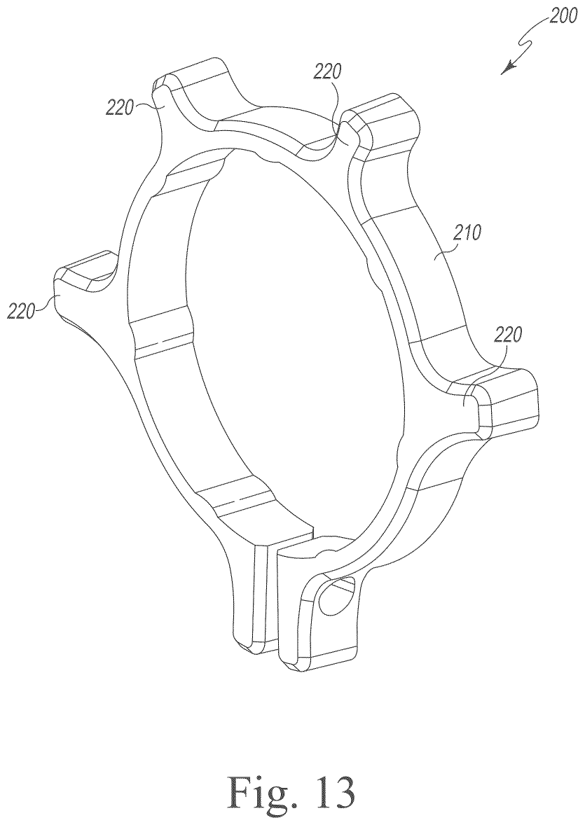

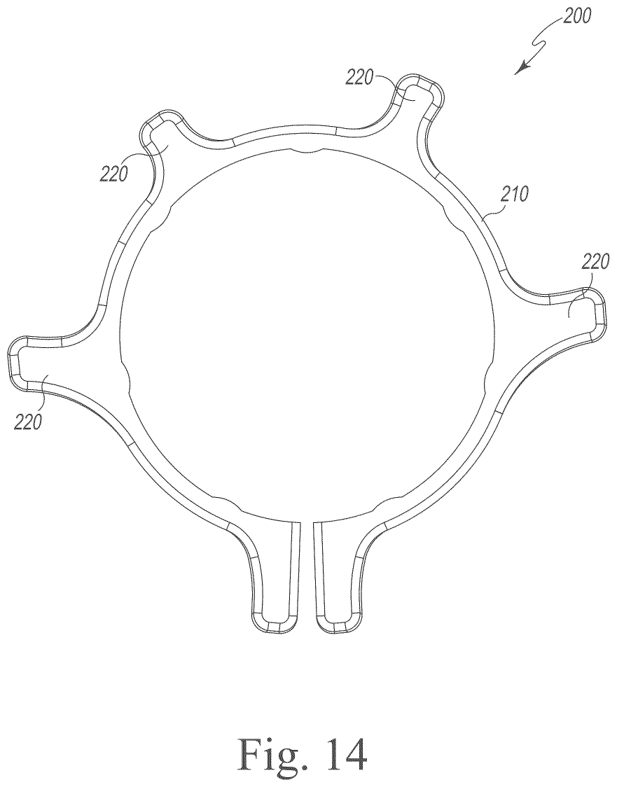

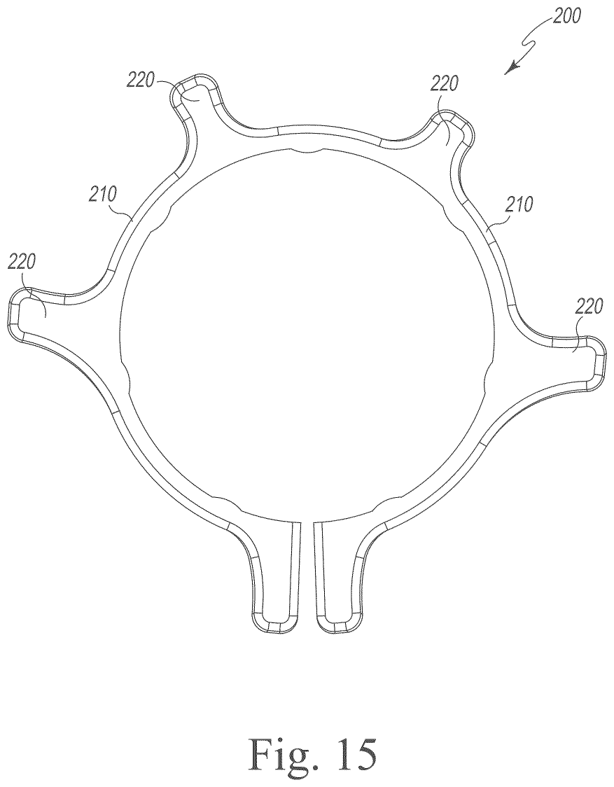

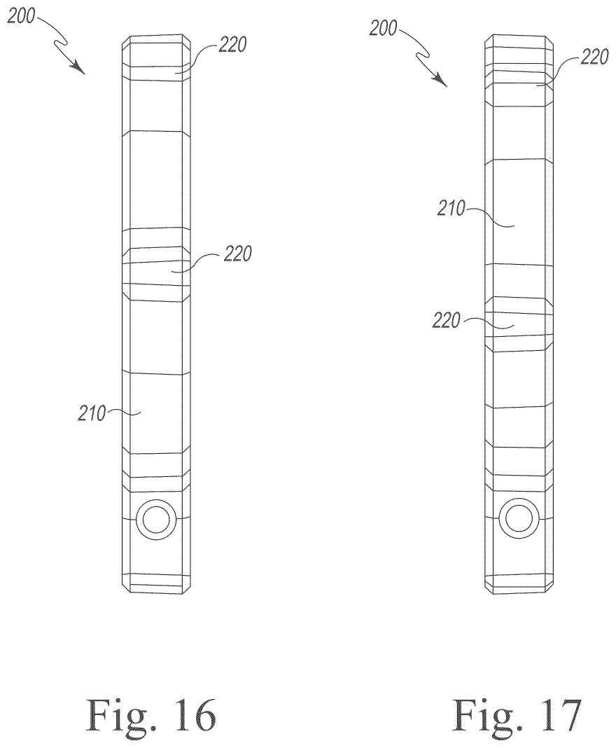

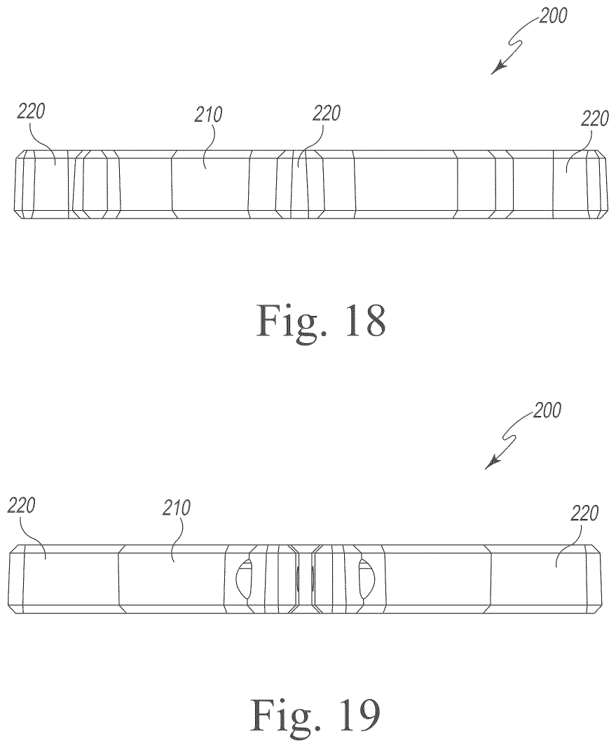

FIGS. 13-19 illustrate a second embodiment of the clamp body of the scope attachment of this invention. The clamp body is designated generally as reference numeral 210. Clamp body 210 is generally identical in construction and function as that of scope attachment 100, but differs in the orientation and spacing of lever arms 220. As shown, lever arms 220 are more uniformly spaced along the upper half of clamp body 210.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

1. An attachment for a variable magnification optic scope including a rotating annular magnification ring having a plurality of magnification indicia and a recessed channel formed therein, the attachment comprising:
an attachment body adapted to mount around the magnification ring of the scope, and a plurality of lever arms extending radially from the attachment body, each of the plurality of lever arms spaced from one another and positioned to align and extend over one of the plurality of magnification indicia.

2. The attachment of claim 1 wherein the attachment body has an inner surface adapted to contact the magnification ring of the scope and an outer surface spaced from the magnification ring.

3. The attachment of claim 2 wherein the plurality of lever arms extends integrally outward from the outer surface of the attachment body.

4. The attachment of claim 2 wherein the attachment body includes an element integrally extending from the inner surface of the attachment body and configured to seat within the recessed channel in the magnification ring when the attachment body is mounted to the magnification ring.

5. An attachment for a variable magnification optic scope including a rotating annular magnification ring having a plurality of magnification indicia and a recessed channel formed therein, the attachment comprising:
an attachment body adapted to mount around the magnification ring of the scope; and
a plurality of lever arms extending radially from the attachment body, each of the plurality of lever arms spaced from one another and positioned to align and extend over one of the plurality of magnification indicia,
the attachment body has an inner surface adapted to contact the magnification ring of the scope and an outer surface spaced from the magnification ring, the attachment body also includes an element integrally extending from the inner surface of the attachment body and configured to seat within the recessed channel in the magnification ring when the attachment body is mounted to the magnification ring,
the plurality of lever arms extends integrally outward from the outer surface of the attachment body.
